(19) United States
(12) Patent Application Publication
(10) Pub. No.: US 2005/0271430 A1
(43) Pub. Date: Dec. 8, 2005

(54) Image forming apparatus

(76) Inventors: Kyoichi Mizuno, Tokyo (JP); Kazunobu Miura, Tokyo (JP); Ken Nonaka, Tokyo (JP); Kunihiro Kawachi, Tokyo (JP); Shinichi Kawabata, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/049,847

(22) Filed: Feb. 2, 2005

(30) Foreign Application Priority Data
Jun. 2, 2004 (JP) JP2004-164377

(51) Int. Cl. G03G 15/20

(52) U.S. Cl. 399/322

(57) ABSTRACT

A fixing device utilized in an image forming apparatus for fixing an image on a recording sheet comprises a heating member including a heating device, a pressure roller which presses the recording sheet to the heating member, a temperature sensor for detecting the heating member and an entry preventing member provided in an upstream side of the temperature sensor for preventing recording sheet from entering into a place where the temperature sensor is attached.

This application is based on patent application No. Tokugan 2004-164377 filed in Japan, the entire content of which is hereby incorporated by reference.

### BACKGROUND

1. Field of the Invention

The present invention relates to a fixing device utilized in the image forming apparatus, for example, a copying machine, a printer, a facsimile machine and a multifunction machine.

2. Description of the Related Art

In an image forming apparatus based on electro-photographic technology such as a copying machine, a printer and a facsimile machine, a latent image corresponding to a document is formed on a photoreceptor and toner is adhered to this latent image so as to develop the toner image. The toner image developed in this manner is finally transferred to a recording sheet. Then the toner image formed on the recording sheet is fixed on the recording sheet.

A fixing device for fixing the toner image onto the recording sheet is based on the heating member fixing technique wherein heat and pressure are applied to the recording sheet with toner image formed thereon by a heating member incorporating a halogen heater or the like and a pressure roller, while the aforementioned recording sheet is carried as it is sandwiched between the heating member and the pressure roller. This type of fixing device is widely used in an extensive field because of its simple structure and excellent fixability of the images onto the recording sheet.

Further, the heating member temperature is controlled by a temperature sensor for detecting the heating roller surface temperature by contacting the temperature sensor with the surface of the heating member. The temperature sensor comprises, for example, a thermistor for detecting temperature and a suspension plate, etc. for supporting the thermistor.

In the fixing device, the recording sheet is fed between the pressure roller and the heating member while the pressure roller presses the heating member. Accordingly, the recording sheet happen to be convolved between these two members and paper jam occurs. Then recording sheet feed is suspended in some cases. If this has occurred, the recording sheet convolved between both members has to be removed and the pressure of the pressure roller had to be released in order to remove the paper jam.

A guide member for guiding the recording sheet is provided on the upstream and downstream sides in the conveyance direction of the recording sheet with respect to both members. After the recording sheet has passed through the members, it may contact the guide member to cause a paper jam. If the heating member convolves the jammed recording sheet, it may proceed to the temperature sensor to deform the temperature sensor, or may detach the temperature sensor from the heating member. This may result in inaccurate temperature sensing. To solve this problem, a separator claw in contact with the heating member is arranged so that the recording sheet will not contact the heating member to be convolved by the heating member.

On the other hand, a heating member is attached on the pressure roller and a temperature sensor is provided on the heating member in order to prevent the temperature sensor from being damaged or contaminated when clearing a paper jam. When clearing the paper jam, the pressure roller is moved downward. This procedure allows the heating member to fall down by its own weight and as a result the heating member is detached from the temperature sensor. A fixing device incorporating such arrangements is disclosed in Official Gazette of Japanese Patent Tokkaihei 11-65350 (Patent Document 1).

As described above, in a fixing device equipped with the separator claw, it is difficult to completely prevent the recording sheet from being convolved by the heating member. Still, the heating member convolves the recording sheet in close contact with the heating roller and the recording sheet passes through the separator claw. Then it reaches the temperature sensor to deform it or to cause inaccurate temperature detection.

Further, when the heating member is installed into the apparatus or the temperature sensor is cleaned at the time of assembling and maintenance, pressure may be applied to the temperature sensor so that the supporting member of the temperature sensor is subjected to plastic deformation beyond the limitation amount of elastic deformation.

The fixing device described in Patent Document 1 fails to prevent the recording sheet from being convolved in the heating member and brought to the temperature sensor. Thus, it is incapable of avoiding deformation of the temperature sensor or inaccurate temperature detection.

### SUMMARY OF THE INVENTION

In view of the problems in the related art described above, it is an object of the present invention to provide a fixing device capable of preventing a recording sheet from reaching a temperature detecting device (temperature sensor), even if the recording sheet being in close contact with the heating roller has been convolved by the heating roller, and capable of protecting the temperature detecting means against damages, even if the recording sheet reaches to the temperature detecting means.

An object of the present invention can be achieved as following.

In accordance with one aspect of the present invention, a fixing device utilized in an image forming apparatus for fixing an image on a recording sheet comprises a heating member including a heating device, a pressure roller which presses the recording sheet to the heating member, a temperature sensor for detecting the heating member and an entry preventing member provided in an upstream side of the temperature sensor for preventing recording sheet from entering into a place where the temperature sensor is attached.

In accordance with another aspect of the present invention, a fixing device utilized in an image forming apparatus comprises a heating member including a heating device, a pressure roller which presses the recording sheet to the heating member, a temperature sensor for detecting the heating member and a regulating member for regulating deformation of the temperature sensor within a predetermined range.

According to the image forming apparatus of the present invention, even when the heating member convolves a recording sheet in close contact with the heating roller, the entry-preventing member prevents the entry of the recording sheet. Consequently the recording sheet cannot reach the temperature sensor. This arrangement prevents deformation of the temperature sensor and inaccurate temperature detection. Even if an entered recording sheet passes through the entry preventing member and reaches to the temperature sensor, the regulating member regulates the deformation of the temperature sensor. This arrangement protects the temperature sensor against possible damages.

### BRIEF DESCRIPTION OF THE DRAWINGS

FIG. 1 is a block diagram of an image forming apparatus;

FIG. 2 is a cross sectional view of the major portion of the image forming apparatus;

FIG. 3 is a configuration block diagram of the fixing device;

FIG. 4 is a configuration block diagram of the fixing device wherein a recording sheet is convolved by a heating roller; and

FIG. 5 is a drawing representing the heating roller pressing against a temperature sensor.

### DESCRIPTION OF THE PREFERRED EMBODIMENT

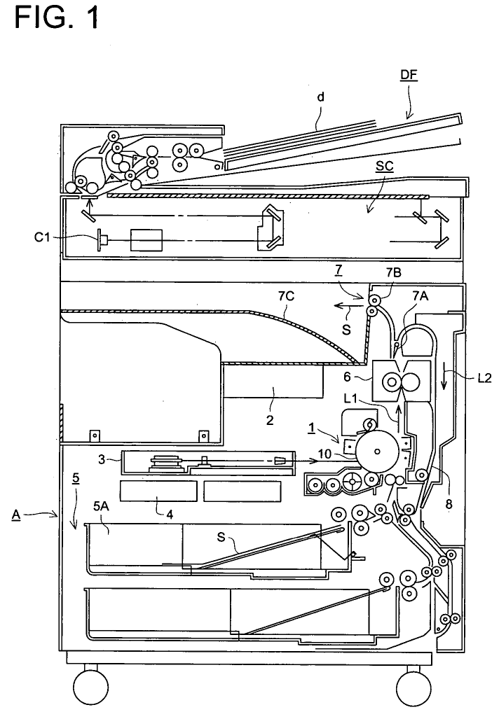

An embodiment of the image forming apparatus equipped with a fixing device of the present invention will be described as following by referring to FIG. 1.

Image forming apparatus main body A includes image forming device 1, image processing device 2, exposing device 3, high voltage power source 4, document feeder/conveyance device 5, fixing device 6, ejection section 7 and automatic document re-feeding mechanism (ADU mechanism) for automatic duplex copying 8.

Image scanner SC and automatic document feeder DF are mounted on image forming apparatus main body A. Ejection tray 7C is provided on the side of ejection section 7 of image forming apparatus main body A, and a recording sheet finishing apparatus (not illustrated) can be connected thereto.

Document d, placed on the document platen of automatic document feeder DF, with the first surface facing upward, is fed in the arrow marked direction. An image on one side or both sides is scanned by the optical system of image scanner SC and is read by CCD image sensor C1. The analog signal having been subjected to photoelectric conversion by CCD image sensor C1 is then subjected to analog processing, analog-to-digital conversion, shading correction and image compression in image processing device 2 and is outputted to exposing device 3.

In exposing device 3, beams outputted from a semiconductor laser is applied to photoreceptor 10 of image forming device 1 so that a latent image is formed. In image forming device 1, processing of electric charging, exposure, development, transfer, separation and cleaning are carried out and an image is transferred onto recording sheet S (a paper sheet). After the image has been fixed onto recording sheet S, then it is ejected to ejection tray 7C. Recording sheet S having undergone the processing of one-side image is subjected to double-side image processing in image forming device 1, and is ejected to ejection tray 7C.

In the image forming apparatus main body A, document feeder cassette 5A of document feeder/conveyance device 5 is located lower portion of image forming device 1, and fixing device 6 and ejection section 7 are arranged above image forming device 1. Recording sheet conveyance path L1 which is set in the substantially vertical direction is formed by this perpendicular arrangement. Recording sheet S fed from document feeder cassette 5A is fed along this vertical recording sheet conveyance path L1 located upward in the vertical direction and is ejected to ejection tray 7C.

Recording sheet conveyance path L2 based on sheet re-feed mechanism 8 is arranged in substantially parallel to the vertical recording sheet conveyance path L1. Arrangement of two vertical recording sheet conveyance paths L1 and L2 provides the shortest recording sheet conveyance path from document feeder cassette 5A to ejection section 7.

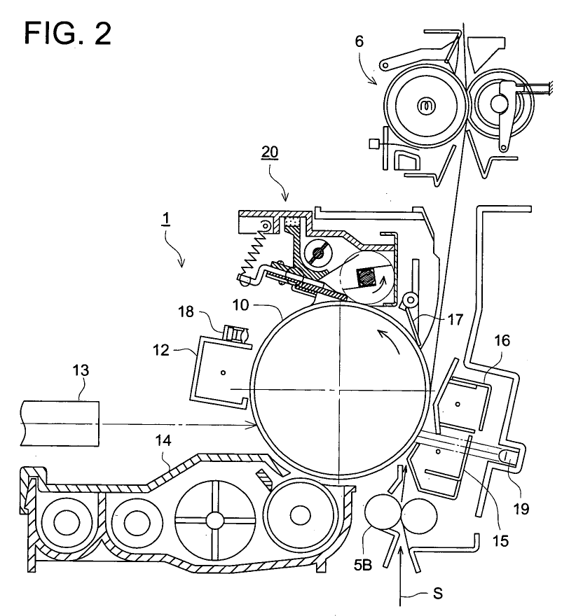

FIG. 2 is a cross sectional view of the major portion of image forming apparatus 1.

In FIG. 2, numeral 10 denotes a photoreceptor as an image carrier, which comprises an organic or inorganic photoconductive layer arranged on the surface of a substrate. It is driven in the arrow-marked direction. Numeral 12 is a charging device configured by a corona-charging device to charge surface of photoreceptor 10 uniformly. The numeral 13 is an exposing device for irradiating an optical image on photoreceptor 10 and forming an electrostatic latent image. Numeral 14 indicates a developing device for forming a toner image by developing the electrostatic latent image formed on photoreceptor 10. Numeral 5B denotes a registration roller which feeds recording sheet S fed from document feeder cassette 5A to a transfer position by synchronizing it with the formation of an electrostatic latent image on photoreceptor 10. Numeral 15 denotes a transferring device including a corona discharger for transferring the toner image on photoreceptor 10 to recording sheet S. Numeral 16 shows a corona discharger for separation and is used for separating the transfer sheet P on which the image has been transferred from photoreceptor 10. A separator claw 17 pressed against the surface of photoreceptor 10. It serves to separate recording sheet S from photoreceptor 10. Numeral 18 is electric charge eliminator applied prior to charging, and numeral 19, a simultaneous transfer-exposing device. Numeral 6 denotes a fixing device for fixing the toner image onto recording sheet S, and 20, a cleaning apparatus for removing residual toner from photoreceptor 10.

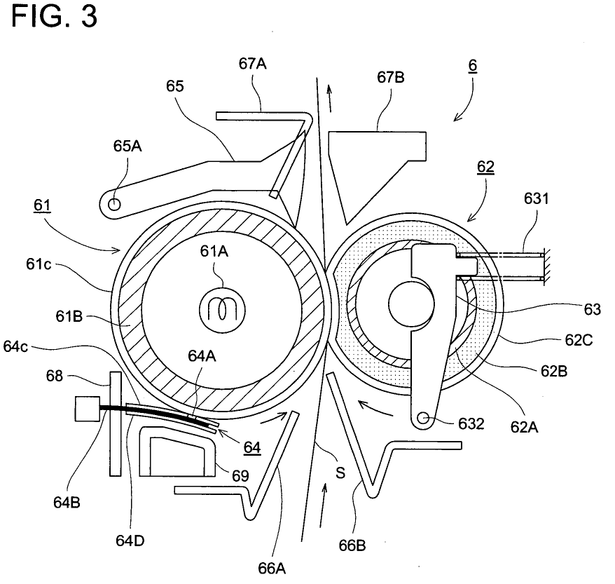

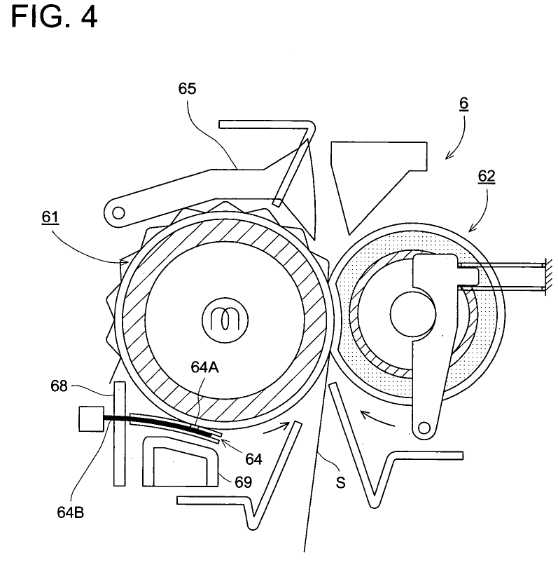

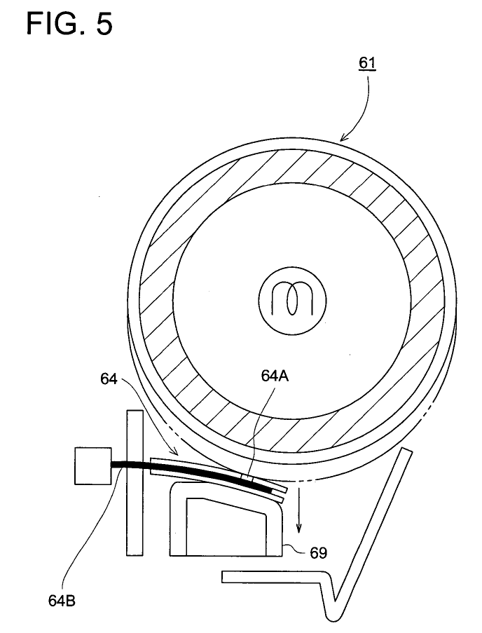

The fixing device of the present invention will be described by referring to FIGS. 3-5. FIG. 3 shows a configuration block diagram of the fixing device. FIG. 4 shows a configuration block diagram of the fixing device wherein a recording sheet is convolved by a heating roller. FIG. 5 is a drawing representing the heating roller pressing against a temperature sensor.

In fixing device 6 shown in FIG. 3, numeral 61 denotes a heating roller. It has a heating section 61A built in the central portion having a halogen heater and magnetic induction rotary member for thermal fixing of a toner image. Heating device 61A includes core bar 61B formed by aluminum, iron, steel or alloy thereof, and a mold releasing layer 61C covered with a fluorine resin such as PFA (perfluoro alkoxy) or polytetrafluoroethylene (PTFE).

Numeral 62 is a pressure roller comprises core bar 62A formed by stainless steel, elastic layer 62B formed by foamed silicone rubber and mold releasing layer 62C coated with PFA or the like. Pressure roller 62 is energized by compression spring 631 and is pressed against heating roller 61 by means of energizing member 63 being rotary on spindle 632. Heating roller 61 is rotated in the counterclockwise direction by the drive source (not illustrated), so that pressure roller 62 is driven in the clockwise direction.

Numeral 64 is a temperature sensor (temperature sensor) including sensing unit 64A for detecting the temperature and supporting member 64B for supporting sensing unit 64A mounted thereon. Sensing unit 64A comprises of a thermistor and other. Supporting member 64B comprises a plate-formed elastic body and is sandwiched between polyimide sheet 64C and PTFE sheet 64D. Polyimide sheet 64C of sensing unit 64A is pressed against heating roller 61 by the elastic force of supporting member 64B. Heating device 61A is controlled by controller (not illustrated) in such a way that the temperature on the surface of heating roller 61 is kept constant by constantly sensing the temperature on the surface of heating roller 61.

Numeral 65 denotes a separator claw. Centered with respect to spindle 65A, separator claw 65 is pressed against heating roller 61 by an energizing member (not illustrated), and separates from heating roller 61 recording sheet S for which fixing process has been terminated.

Temperature sensor 64 is located downstream of separator claw 65 in the rotating direction of heating roller 61.

Numerals 66A and 66B denote upstream guide members, and 67A and 67B indicate downstream guide members.

As described above, recording sheet S with a toner image formed thereon is fed from lower portion of the image forming apparatus 1 and is sandwiched between the nip portions of heating roller 61 and pressure roller 62, where recording sheet S is heated and pressed. Recording sheet S with the toner image fixed thereon is fed upward as shown in the FIG. 3 and is ejected to ejection section 7 shown in FIG. 1.

In some cases, a paper jam occurs due to recording media S being incorrectly fed. Some of recording media S stick to heating roller 61 and slip through separator claw 65. If such recording media S are fed inside along heating roller 61 by the rotation of heating roller 61, separator claw 65 causes the tip end of recording sheet S to reach temperature sensor 64 located downstream, with the result that temperature sensor 64 is damaged or inaccurate temperature detection is caused by sensing unit 64A being detached from heating roller 6i. Such a problem may occur in some cases.

The present invention uses the arrangement as shown in FIG. 4 to solve this problem.

In FIG. 4, entry preventing member 68 for preventing the entry of a recording sheet is provided downstream of separator claw 65 in the rotating direction of heating roller 61 and upstream of temperature sensor 64 in the rotating direction of heating roller 61. Thus, even if the incoming recording sheet sticking to heating roller 61 should have slipped through separator claw 65, it is brought in contact with entry preventing member 68, which prevents recording sheet S from reaching the temperature sensor. This arrangement prevents deformation of temperature sensor 64 and inaccurate temperature detection.

It is preferred that entry preventing member 68 be located as closely as possible to temperature sensor 64. Entry preventing member 68 may or may not be in contact with temperature sensor 64. When entry preventing member 68 is in contact therewith, the entry of recording sheet S can be more effectively avoided. In this case, it is necessary to use such a soft material as resin material so that temperature sensor 64 will not be damaged. Care should be taken to ensure that the contact portion is formed in a circular shape.

The temperature sensor protected by entry preventing member 68 need not always be the aforementioned one. It can be a sponge type temperature sensor comprises a sensor arranged on a sponge, a thermocouple type temperature sensor or a non-contact temperature sensor. Alternatively, it can be a thermostat.

Regulating member 69 for regulating the deformation of the temperature sensor is provided face to face with temperature sensor 64 on the reverse side of the temperature roller 64. If an incoming recording sheet S has slipped through entry preventing member 68 to reach temperature sensor 64, supporting member 64B will be deformed. However, regulating member 69 keeps the deformation of supporting member 64B within the range of elastic deformation, and supporting member 64B is protected against plastic deformation, with the result that temperature sensor 64 is perfectly impervious to any damage. Thus, when a paper jam occurs, all has to do is just removing recording sheet S. Then supporting member 64B is reset to the original state, and correct operations are resumed thereafter.

In order to ensure easier positioning with respect to the heating roller 64 and to protect the heating roller 64 and temperature sensor 64 against, it is preferable that entry preventing member 68 and regulating member 69 be integrally formed into one unit by heat-proof resin materials.

When heating roller 61 is assembled or is replaced at the time of maintenance, heating roller 61 may be placed below the normal level and heating roller 61 so that supporting member 64B is deformed may press temperature sensor 64. However, as shown in FIG. 5, since regulating member 69 supports the deformed supporting member 64B, supporting member 64B is kept within the range of the elastic deformation and is immune to plastic deformation. This arrangement ensures that temperature sensor 64 is perfectly free of any trouble.

Further, when cleaning temperature sensor 64A, pressure is applied to temperature sensor 64. In the same manner as above, however, there is no problem even if temperature sensor 64 is subjected to deformation.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom. For example, a heating belt can be used instead of the heating roller.

1. A fixing device utilized in an image forming apparatus for fixing an image on a recording sheet, the fixing device comprising:
a heating member including a heating device;
a pressure roller which presses the recording sheet to the heating member;
a temperature sensor for detecting temperature of the heating member; and
an entry preventing member provided in an upstream side of the temperature sensor for preventing a recording sheet from entering into a place where the temperature sensor is attached.

2. The fixing device of claim 1,
wherein the entry preventing member is formed by anti-heat resin.

3. The fixing device of claim 1,
wherein the entry preventing member is provided in contact with the heating member.

4. The fixing device of claim 1,
wherein the entry preventing member is provided in non-contact with the heating member.

5. The fixing device of claim 1,
wherein the temperature sensor comprises a sensing unit for detecting temperature, the sensing unit being in contact with the heating member, and a supporting member for supporting the sensing unit,
wherein the supporting member is an elastic board material.

6. The fixing device of claim 1, further comprising:
a regulating member for regulating deformation of the temperature sensor within a predetermined range.

7. The fixing device of claim 6,
wherein the entry preventing member and the regulating member are integrated into one unit formed by resin.

8. The fixing device of claim 1, further comprising:
a separator claw for separating the recording sheet from the heating member, the separator claw being provided in an upper stream side of the entry preventing member.

9. A fixing device utilized in an image forming apparatus for fixing an image on a recording sheet, the fixing device comprising:
a heating member including a heating device;
a pressure roller which presses the recording sheet to the heating member;
a temperature sensor for detecting temperature of the heating member; and
a regulating member for regulating deformation of the temperature sensor within a predetermined range.

10. The fixing device of claim 9,
wherein the regulating member is formed by resin.

11. The fixing device of claim 9,
wherein the temperature sensor comprises a sensing unit for detecting temperature, the sensing unit being in contact with the heating roller and a supporting member being an board of an elastic member for supporting the sensing unit.

12. The fixing device of claim 11,
wherein the regulating member is arranged so that deformation of the supporting member is regulated within an elastic deformation range of the elastic member by contacting the supporting member with the heating member in case the temperature sensor is deformed.

13. The fixing device of claim 9,
wherein the regulating member is arranged so that the regulation member regulates deformation of the temperature sensor within a predetermined range in case the recording sheet convolved into the heating roller enters into the temperature sensor and deforms the temperature sensor.

14. The fixing device of claim 9,
wherein the regulating member regulates deformation of the temperature sensor within a predetermined range when the heating member presses the temperature sensor in case of exchanging the heating member.

15. The fixing device of claim 9,
wherein the regulating member is provided in a position facing the temperature sensor.

16. A fixing device utilized in an image forming apparatus for fixing an image of a recording sheet, the fixing device comprising:
a heating member including a heating device;
a pressure roller which presses the recording sheet to the heating member;
a temperature sensor for detecting temperature of the heating member; and,
a transformation preventing member for preventing transformation of the temperature sensor attached adjacent to the temperature sensor.

17. The fixing device of claim 16,
wherein the transformation preventing device is attached in an upstream of the temperature sensor for preventing the a recording sheet from entering into the temperature sensor.

18. The fixing device of claim 16,
wherein the transformation preventing device is a regulating member for regulating transformation of the temperature sensor within a predetermined range.

19. The fixing device of claim 16,
wherein the transformation preventing device into which an entrance preventing member for preventing entrance of the recording sheet and a regulating member for regulating transformation of the temperature sensor within a predetermined range are integrally formed is attached in an upstream side of the temperature sensor.

20. The fixing device of claim 16,
wherein the transformation preventing member is formed by anti-heat resin.
